(19) United States
(12) Patent Application Publication
(10) Pub. No.: US 2017/0323227 A1
(43) Pub. Date: Nov. 9, 2017

(54) SYSTEM FOR MANAGING PARKING SPACES USING ARTIFICIAL INTELLIGENCE AND COMPUTER VISION

(71) Applicant: Arash Sadeghi, Princeton, NJ (US)

(72) Inventor: Arash Sadeghi, Princeton, NJ (US)

(21) Appl. No.: 15/587,633

(22) Filed: May 5, 2017

Related U.S. Application Data
(60) Provisional application No. 62/332,355, filed on May 5, 2016.

(51) Int. Cl. G06Q 10/02; G06Q 20/10; G06Q 30/02; H04L 29/06; G08G 1/14

(52) U.S. Cl. CPC G06Q 10/02; G06Q 30/0259; H04L 63/0428; G06Q 20/102; G06Q 30/0267; G08G 1/14; G06Q 2240/00

(57) ABSTRACT

A parking space management system comprising a plurality of parking meters and a backend server. Each of the parking meters includes a respective main body, processor, sensor and transceiver. The sensor is configured to sense visual information relating to one or more parking spaces associated with the respective parking meter and the transceiver is configured to externally transmit the sensed visual information. The backend server remotely controls the parking meters. The backend server receives the transmitted sensed visual information from the parking meters, processes the received sensed visual information via computer vision to determine an occupancy status of the parking spaces associated with the parking meters, and controls the parking meters to display a first status notification indicative of the determined occupancy status of the associated parking spaces. The backend server also establishes a reservation for selected parking spaces and controls each parking meter associated with each reserved parking space to display a second status notification indicative of the reservation. Additional features and capabilities also are provided.

### REFERENCE TO RELATED APPLICATION

This application claims priority to U.S. Provisional Patent Application No. 62/332,355, filed on May 5, 2016, the disclosure of which is incorporated herein by reference.

### FIELD OF INVENTION

The present invention is directed to a system for managing parking spaces using artificial intelligence and computer vision. The present invention is more particularly directed to a system for detecting parking spot vacancy using enhanced parking meters with vision-based data acquisition features and implementing reservations and enforcement of parking spaces using real-time information. The present invention may be employed in various environments, including public and private streets, outdoor and indoor parking facilities (e.g., parking lots), and private residences.

### BACKGROUND

Monetizing parking spaces is one of the main sources of revenue for municipalities. The most common form of space utilization by parking authorities includes investing in a parking meter infrastructure, consisting of individually designated parking spots, specified by road markings, with an associated parking meter. The meters typically accept coins in the form of payment, and thus are conventionally built out of thick metal shells, analogous to a security box, to be impervious to outside attempts to gain access to the contents.

The meters, in addition to having a mechanism for sorting coins, are now more recently accepting card payments and mobile app-based purchases, have a feature by the means of which they communicate their current status to an enforcement officer. This could be in the form of a red/expired indicator on the meter or raising a digital flag wirelessly. This would require enforcement officers to continuously patrol the area, in search of expired meters in order to issue fines to violators. In the case of wireless notifications, the officer has to travel to the location to issue the citation, which also adds to the traffic, and during which time the motorist may leave the area. Typically, a comparatively few number of enforcement officers are tasked with monitoring a large number of parking meters, so enforcement is very inefficient and at best random.

On the customer side, the parking experience is exacerbated by the need for finding a vacant parking spot, which often results in having to circle the area contributing to more traffic and pollution, wasting time and fuel. Once an empty spot is acquired, additional sources of inconvenience may include not having the correct amount of change (or other forms of payment) and the possibility of getting fined for not being able to return to the spot in time to either drive away or extend the parking duration by adding payment.

### OBJECTS AND SUMMARY OF THE INVENTION

In view of the foregoing, it is an object of the present invention to provide a system for managing parking spaces by implementing enhanced parking meters and analyzing real-time information via computer vision techniques. It is a further object of the present invention to provide a parking space management system in which local retailers utilize the system to promote their businesses and attract more customers through providing targeted advertisements. It is a further object of the present invention to provide multiple smart parking meters in an area to capture real-time visual information to be used in generating a three-dimensional depth map of the area and utilize the depth map to improve navigation, routing and/or parking of autonomous vehicles.

To achieve one or more of the foregoing and other objects, the present invention, in accordance with various embodiments, is a parking space management system that comprises a plurality of parking meters, each of the parking meters including a respective main body, processor, sensor and transceiver, the sensor of each parking meter configured to sense visual information relating to one or more parking spaces associated with the respective parking meter, and the transceiver configured to externally transmit the sensed visual information. The system further comprises a backend server configured to remotely control a selected one or more of the parking meters. The backend server is further configured to receive the transmitted sensed visual information from the parking meters, process the received sensed visual information via computer vision to determine an occupancy status of the parking spaces associated with the parking meters, control at least one of the parking meters to display a first status notification indicative of the determined occupancy status of the parking spaces associated with the parking meters, and establish a reservation for a selected parking space and control the parking meter associated with the reserved selected parking space to display a second status notification indicative of the reservation.

As an aspect of the invention, the backend server is configured to establish the reservation upon receipt of a request for a reservation transmitted from an external device.

As a feature of this aspect, the reservation includes at least one vehicle identification information.

As another feature of this aspect, the backend server is configured to determine whether the vehicle identified by the vehicle identification information included in the reservation has entered the reserved selected parking spot, and the backend server is configured to control the parking meter associated with the reserved selected parking space to display a third status notification indicative of a violation when it is determined that a vehicle different than the vehicle identified by the vehicle identification information has entered the reserved parking space.

As a further feature of this aspect, the backend server is configured to disable a processing of a payment for parking in the reserved parking space when it is determined that a vehicle different than the vehicle identified by the vehicle identification information has entered the reserved parking space.

As yet another feature of this aspect, the backend server is configured to make the determination of whether the vehicle identified by the vehicle identification information included in the reservation has entered the reserved selected parking spot by ascertaining the make, model and/or color of the vehicle in the reserved parking space from the received sensed visual information of the reserved parking space and comparing the ascertained information with the vehicle identification information included in the reservation.

As still yet a further feature of this aspect, the backend server is configured to make the determination of whether the vehicle identified by the vehicle identification information included in the reservation has entered the reserved selected parking spot by utilizing location information of the vehicle identified by the vehicle identification information in the request for reservation.

As another aspect of the invention, each of the parking meters includes a beacon disposed on or within the main body and configured to display a selected one of a plurality of different status notifications.

As a further aspect of the invention, each of the parking meters includes an infrared sensor to detect a heat map of the parking space(s) associated with the respective parking meter.

As yet another aspect of the invention, each of the parking meters includes a plurality of solar cells and a power source configured to power the respective parking meter and configured to be rechargeable via the respective solar cells.

As still yet a further aspect of the invention, each of the parking meters is configured to receive power from an external power source and further configured to operate as a charging station for one or more electric vehicles.

As a further aspect of the invention, the backend server is configured to initiate a timer having a predetermined amount of time when a parking space becomes occupied.

As a feature of this aspect, the backend server is configured to control a parking meter associated with an occupied parking space to display a third status notification indicative of a violation when the timer expires and a payment for the occupied parking space has not been processed.

As yet another aspect of the invention, the backend server is configured to process sensed visual information received from a predetermined plural number of the parking meters to generate a three-dimensional depth map of areas surrounding the predetermined plural number of the parking meters.

As a feature of this aspect, the backend server is configured to provide the generated depth map to an autonomous vehicle both in communication with the backend server and disposed within a predetermined distance of the predetermined plural number of the parking meters.

As still yet a further aspect of the invention, the system further comprises a storage having stored therein a database of advertisements from retailers located within a predetermined area in association with the plurality of parking meters, wherein the backend server is configured to detect an arrival of a vehicle within a selected parking space, select at least one of the advertisements within the database of advertisements stored in the storage, the selected advertisement being associated with a retailer having a physical location disposed within a predetermined walking distance from the selected parking space, and transmit, at the arrival of the vehicle within the selected parking space, the selected advertisement to a mobile device associated with an operator of the vehicle.

In accordance with further embodiments, the invention is also directed to a method of managing parking spaces, the method comprising obtaining visual information relating to one or more parking spaces associated with each of a plurality parking meters, processing the obtained visual information via computer vision to determine an occupancy status of the one or more parking spaces, controlling the plurality of parking meters to display a first status notification indicative of the determined occupancy status, establishing a reservation of a parking space associated with at least one parking meter, and controlling the at least one parking meter to display a second status notification indicative of the reservation.

As an aspect of this embodiment, the method further comprises processing the obtained visual information to generate a three-dimensional depth map of areas surrounding the plurality of parking meters, and providing the generated depth map to one or more autonomous vehicles within a predetermined radius of the plurality of parking meters.

As another aspect of this embodiment, the method further comprises establishing a database of advertisements from retailers within a predetermined area of the plurality of parking meters, detecting an arrival of a vehicle within a selected parking space, selecting an advertisement from the database of advertisements, the selected advertisement being associated with a retailer having a physical location that is within a predetermined walking distance from the selected parking space, and transmitting the selected advertisement to a mobile device associated with an operator of the vehicle at the time of arrival.

In accordance with further embodiments, the invention is also directed to a parking meter, comprising a main body, a sensor disposed on or within the main body, the sensor configured to continuously sense visual information relating to a parking space associated with the parking meter, a beacon disposed on or within the main body and configured to emit at least one of a visual notification and auditory notification indicative of a status of the parking meter, a processor configured to encrypt the sensed visual information to be externally transmitted, and a transceiver configured to transmit the encrypted sensed visual information to an external backend server for computer vision processing.

These and other embodiments, aspects and features of the present invention are described in the following detailed description.

In addition, various other objects, advantages and features of the present invention will become readily apparent to those of ordinary skill in the art from the following detailed description of the invention.

### BRIEF DESCRIPTION OF THE FIGURES

The following detailed description, given by way of example and not intended to limit the present invention solely thereto, will best be appreciated in conjunction with the accompanying drawings, wherein like reference numerals denote like elements and parts, in which:

FIG. 1 is a schematic illustration of a system of interconnected elements operating in accordance with the present invention;

FIG. 2 is a schematic illustration of a smart parking meter in accordance with the present invention;

FIG. 3A is a schematic illustration of an exemplary exterior of the smart parking meter;

FIG. 3B is a block diagram showing the various components of the smart parking meter;

FIG. 4 is a flow chart that shows an operation of the smart parking meter in accordance with the present invention;

FIG. 5 is a flow chart that shows a single-click parking methodology in accordance with the present invention; and

FIGS. 6A-6L are exemplary screenshots of a mobile application (app) in accordance with the present invention.

### DETAILED DESCRIPTION

The present invention pertains generally to a novel system for managing parking spaces. The system in accordance with the present invention includes a backend server that controls and monitors operations of various devices within the system and also oversees use of one or more monitored parking spaces. For example, the backend server in accordance with the present invention receives real-time information from an enhanced parking meter (also referred to herein as a “smart parking meter”) and performs various processing so as to, for example, ascertain occupancy of parking spaces, provide parking space availability information to an interested party, to report any violation or illegality to appropriate enforcement authorities, and more.

Operation of the system in accordance with the present invention provides various benefits and advantages. For instance, the backend server provides real-time information to motorists searching for a parking spot, reducing fuel that is wasted circling the streets in search of a parking spot. In another instance, the backend server allows for reserving of parking spaces within a confined geographic area so as to maximize usage and profit for municipalities. In a further instance, real-time information captured by the parking meters are constantly updated on the backend server to assist in providing additional security benefits to motorists against theft and other crimes, and also to allow enforcement officers to efficiently handle violations either remotely or in person. Finally, use of smart parking meters as described herein provides for a reduced manufacturing cost, increased durability and low overall maintenance.

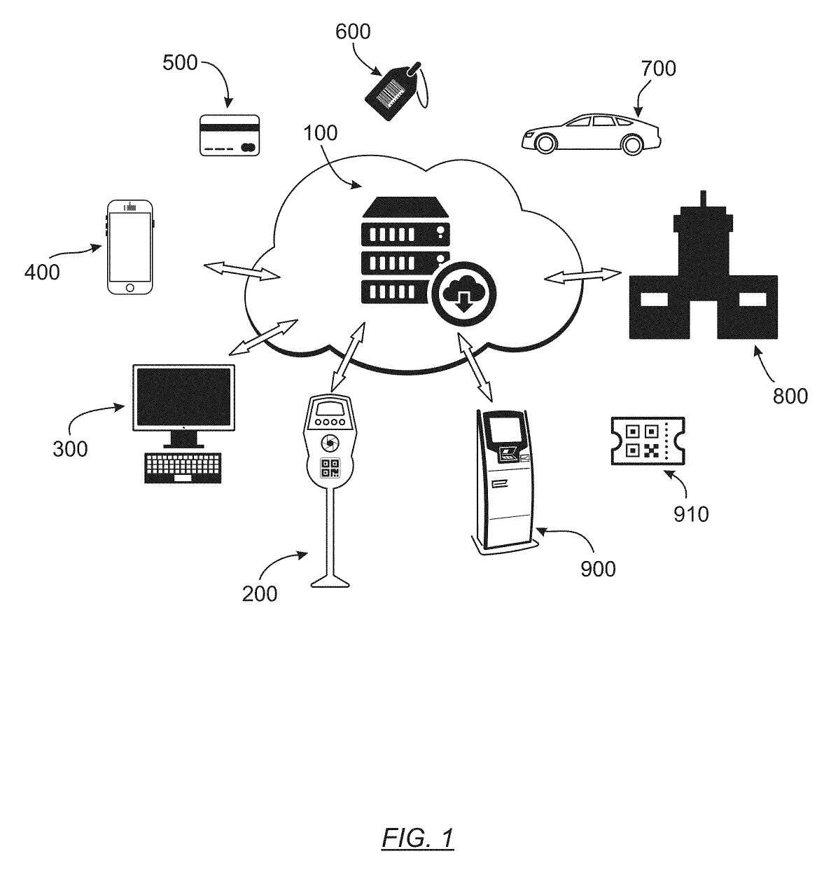

Turning now to the drawings, and particularly to FIGS. 1-6L thereof, the operation of the system in view of the backend server acting as a brain of the system, and also with respect to various other constituents of the system and their interactions within the system, are illustrated.

### I. The System

Referring now to FIG. 1, a schematic illustration of a system of interconnected elements operating in accordance with an embodiment of the present invention to provide a smart street parking management system is provided.

As particularly described herein, the backend server 100 controls the entire operation of the parking management system. The backend server 100 may include, for example, one or more processing units and storage infrastructure abstracted as cloud services. The backend server 100 may also be referred to herein as the “cloud,” “cloud services,” or the “cloud-based” backend server. In some instances, the backend server 100 may be referred to herein as the “central server” where all the processing are carried out.

In accordance with the present invention, the backend server 100 receives real-time information sensed by one or more sensors provided on smart parking meters. The backend server 100 includes computer clusters and/or supercomputers to process the received signals. For example, the backend server 100 may receive signals containing visual information such as still images or motion video of one or more parking spaces associated with a smart parking meter or of areas surrounding the associated parking spaces. The backend server 100 may perform vision object recognition algorithms such as CAD based models, appearance-based and feature-based methods or neural networks and deep learning algorithms to ascertain information from received signals to determine, for example, an occupancy status of the parking spaces. In certain embodiments, different elements of an image are identified by artificial intelligence (A.I.) (e.g., a wheel, a bumper, a car mirror, a person, etc.) and machine learning algorithms constantly refine classifiers. In these embodiments, the cloud-based computer can determine the occupancy status of the parking spaces by identifying whether there is a vehicle present in the picture.

Computer vision techniques for gaining high-level understanding from digital images or videos including event detection, video tracking, object recognition, object pose estimation, or motion estimation have been known to one skilled in the art. For additional details regarding computer vision and other similar techniques, see Norbert Buch et al., “A Review of Computer Vision Techniques for the Analysis of Urban Traffic,” IEEE Transactions on Intelligent Transportation Systems, Vol. 12, No. 3, September 2011, which is incorporated by reference herein.

In certain other embodiments, the backend server 100 may receive signals containing infrared information (e.g., a heat map) of the parking spaces. The cloud-based computer analyzes the information to detect, for example, heat signature of a vehicle's engine and/or presence of any person in or near the vehicle. The cloud-based computer may also determine the occupancy status of the parking spaces based on presence of the heat signature or use the heat information for anti-theft prevention measures by alerting motorists that someone is in or near their vehicles.

In yet certain further embodiments, the backend server 100 may receive signals for making a reservation of the parking spaces based on occupancy information stored on the cloud and prevent other users from parking in the reserved parking spaces. In accordance with the present invention, a reservation for a particular parking space may be made on the spot (e.g., when a user is in the vicinity of the parking spot and ready to park) or may be made for a future time for a specific period of time. In either case, the backend server 100 receives a request for reservation from a user within the system and controls the designated smart parking meter accordingly. In addition, to enforce the reservation feature more efficiently, the reservation information in accordance with the present invention generally includes one or more vehicle identification information such as make, model, and/or color of a vehicle. When the reservation information is received, the cloud-based computer performs a comparison between the received reservation information and information sensed by the sensors provided on the smart parking meter. Based on the comparison, the cloud-based computer may assess whether or not the vehicle disposed in the parking space is a vehicle identified in the vehicle identification information included in the reservation information.

In one version, based on the comparison, the cloud-based computer may control to disable processing of a payment for parking in the parking spot when it is determined that the vehicle disposed in the parking spot is not the vehicle identified in the reservation information. For example, when a reservation of a particular parking spot has been received, the backend server 100 may start a routing session by determining from GPS data where the user is and how far the user is from the spot. During this period, the system detects someone else pulling into the reserved parking spot (e.g., by the cloud-based computer performing vision algorithms to determine occupancy), the backend server 100 recognizes that the new vehicle is in violation, even prior to checking the identity of the new vehicle.

In accordance with the present invention, the backend server 100 also controls a mobile application (app) on users' mobile devices that are used by the users to interact with the system. As will be further described in reference to Section VII herein, the backend server 100 controls, for example, the searching-for-available-parking-space feature, the making-reservations feature, the providing-routing-information feature, and various other functionalities that are provided by the mobile app.

As further described herein, the backend server 100 controls the overall operation of the parking management system by controlling the operation of one or more smart parking meters installed or otherwise located at various locations around a municipality, such as a town, village or city. For convenience, the term “municipality” is used herein to refer to a particular geographic area, such as a town, village, city or other geographic area, but the term municipality is not intended to be limited only to these types/forms of geographic areas. The geographic area of the “municipality” may be very small, mid-size, or very large, and may include a public or private parking lot or parking garage, or a private residence.

The municipality generally has road markings on respective sides of each street designated as street parking areas. Other municipalities may allow street parking even without road markings as long as street signs indicate otherwise. In some municipalities, a plot of land or a building may be designated as communal parking lots. In each of these instances, a parking meter is associated with each of the defined parking spots.

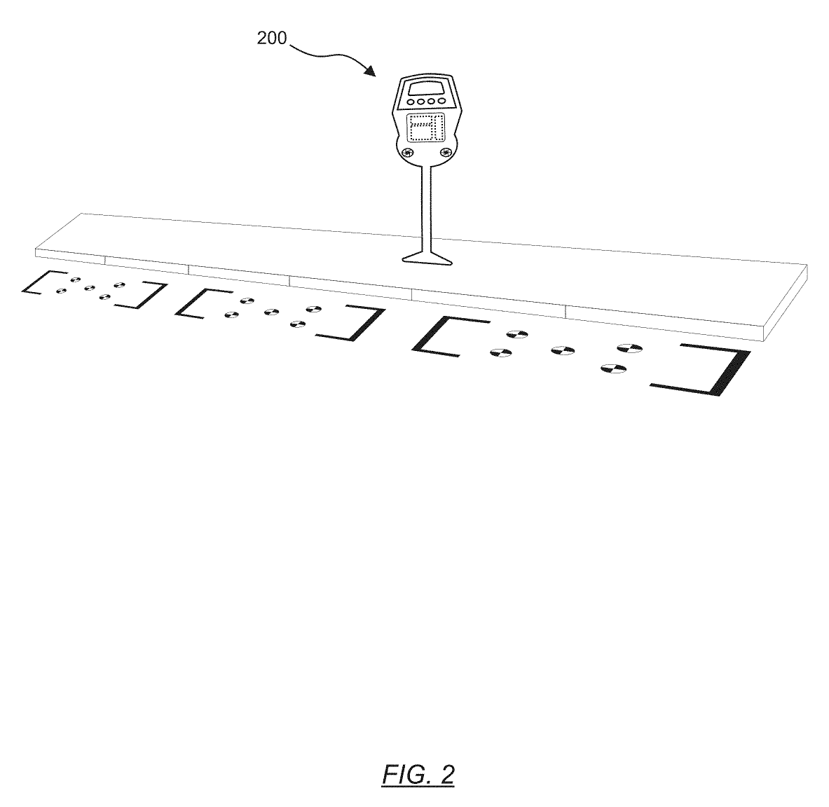

Referring to FIG. 2, an exemplary placement of a smart parking meter 200 of the present invention is illustrated. As shown, the smart parking meter 200 preferably is positioned between parking spots to effectively capture visual information of a parked vehicle (e.g., its front or rear license plate). In a preferred embodiment, the smart parking meter 200 includes two imaging sensors to monitor two different parking spots. In certain embodiments, one smart parking meter of the present invention is employed/utilized for every two parking spots. In certain other embodiments, one smart parking meter is employed for more than two parking spots. In yet other embodiments, one smart parking meter is employed for each parking spot.

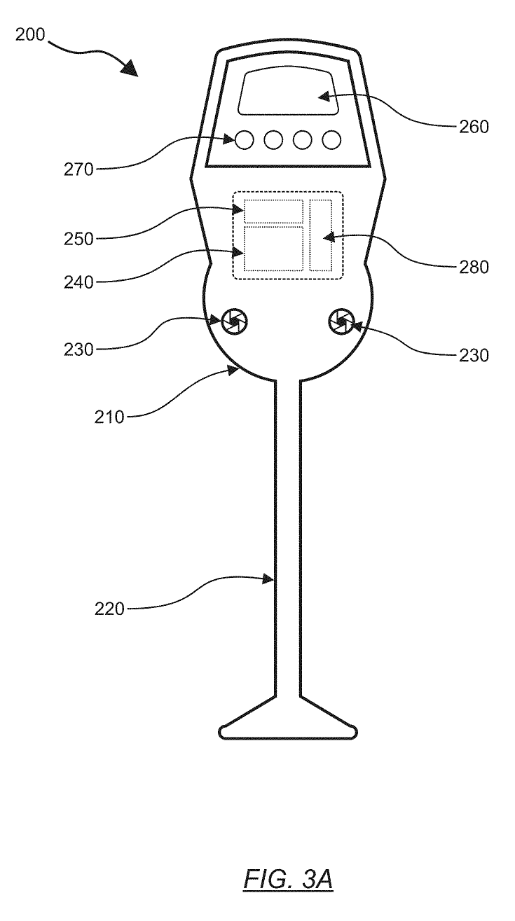

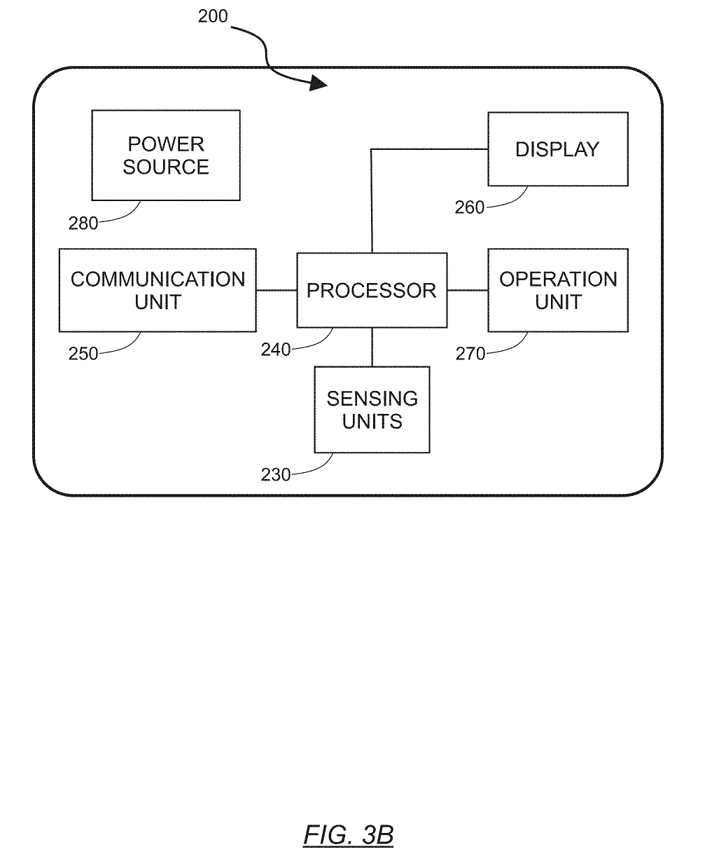

FIG. 3A is a schematic illustration of an exemplary exterior of the smart parking meter 200 of the present invention. FIG. 3B is a block diagram that shows the various components of the smart parking meter 200. Referring to FIGS. 3A and 3B, the smart parking meter 200 includes a main body 210 extending from a pole 220. In certain embodiments, the height of the pole 220 should be such that the sensors of the smart parking meter 200 are positioned between 110 and 130 centimeters (cm) above the ground to allow for optimal performance. The height of the pole, or the smart parking meter apparatus itself, may vary to meet the needs of various other implementation of the present invention (e.g., an indoor parking facility implementation). Ideally, the optimum height of the sensors is directly above the parking space looking down to minimize noise from passing traffic.

In accordance with the present invention, the main body 210 and pole 220 may be integrated with one another or may be distinct components. In one version, the main body 210 of the smart parking meter 200 of the present invention is designed to be installed over an already existing pole. For instance, older meters that are desired to be upgraded or are no longer operational may be replaced relatively quickly with the smart parking meter 200 of the present invention. It is noted that the particular shape of the smart parking meter of the present invention may be modified as desired or appropriate for use on already existing poles or on new poles, and thus the present invention is not limited to the particular structures shown in the figures.

As further illustrated in FIGS. 3A and 3B, the smart parking meter 200 includes a sensing unit 230, a processor 240, a communication unit 250, a display 260, operation units 270 and a power source 280. One or more of these components that are illustrated with dotted lines in FIG. 3A (e.g., the processor 240, the communication unit 250 or the power source 280) may be contained entirely within the main body 210.

In certain embodiments, the sensing unit 230 is a digital vision sensor that operates in the visible and/or infrared range for nighttime/low light level detection. Each digital vision sensor may be a printed circuit board mounted imager, having an image sensor (e.g., a CCD) with or without an optical lens assembly. In certain other embodiments, the digital vision sensor is a pinhole camera (or other type of camera). In yet certain further embodiments, the digital vision sensor has a combination of cameras to provide a wide field of view or a panoramic view (e.g., 180° panoramic view, 270° panoramic view, 360° panoramic view) from the vantage point of the smart parking meter 100. The term “sensor” as used herein broadly refers to any one of the sensors described herein or a collection thereof for sensing visual and/or infrared information from vehicles on or near the parking meter or of the parking space associated with the parking meter irrespective of whether a vehicle (or vehicles) is present or otherwise disposed within (or in a vicinity of) the parking spot.

In certain embodiments, the smart parking meter 200 may further include a proximity sensor, an accelerometer, or a gyro sensor in addition to, or alternatively, as part of the sensing unit 230. In one version, the proximity sensor may be used to initiate the vision sensor. In another version, the accelerometer or the gyro sensor may be used to sense if the smart parking meter 200 has been hit or tampered with in any way. In a further version, the smart parking meter 200 may further include a capacitive or inductive loop sensor, a pressure sensor, a magnetometer, an optical or acoustic proximity sensor installed either within the smart parking meter 200 itself or remote from the smart parking meter 200 but within a predetermined radius of the associated parking spot to initiate an interrupt signal to “wake up” the meter from the sleep mode.

In embodiments in which one smart parking meter is utilized to monitor two adjacent parking spots, the smart parking meter 200 includes two sensing units 230, with each sensing unit imaging a respective parking spot. In embodiments in which one smart parking meter is configured to monitor more than two surrounding parking spots (e.g., four or more), the smart parking meter 200 utilizes any number of sensing units 230 to image each of those parking spots. Accordingly, the parking meter of the present invention is not limited to any particular number of sensing units.

The sensing unit 230, also called a digital vision sensor herein, captures still images or motion video of the associated parking spots and may further capture the surrounding areas of those associated parking spots. The captured or otherwise obtained images are provided to the processor 240 within the smart parking meter 200 where they are packaged and/or encrypted and transmitted to the backend server 100.

The processor 240 may be a CPU, GPU, FPGA, microcontroller or other suitable component, device or system of components suitable for receiving signals from one or more imaging sensors (e.g., supplied from sensing unit 230) and sending encrypted signals to the backend server 100. In certain embodiments, the processor 240 may run a program that queries the status of a parking spot from a database in the cloud server and accordingly sets the color(s) of a beacon disposed on the parking meter. In certain other embodiments, the processor 240 may autonomously carry out processing that is otherwise or normally performed at the backend server 100 during an emergency situation such as a power or communication shutdown at the backend server 100.

The present invention further may employ auxiliary devices and/or auxiliary sensors that are in communication with the smart parking meter 200. In one version, an auxiliary device in the form of calibration markers painted or otherwise provided on the ground (e.g., the pavement) of the parking spot are employed to assist in the ascertaining of the occupancy status of the parking meter by the backend server 100. In such version, the image captured by the vision sensor including, or not including, the calibration markers (or the absence of a certain number of calibration markers) is sent to the backend server 100 where the image is processed.

In certain other embodiments, the occupancy status may be determined using global positioning system (GPS). In one version of such embodiments, the smart parking meter 200 may obtain GPS location information of a particular vehicle or of a user's mobile device and compare the GPS information with location information of the smart parking meter 200 stored within a memory of the smart parking meter 200 or at the backend server 100. In such version, the determination of occupancy status is dispositive upon the location information of the vehicle and the location information of the smart parking meter 200 being within a predetermined threshold.

In yet certain further embodiments, infrared sensing performed by either an infrared sensor within the smart parking meter 200 (as the sensing unit 230) or external to the smart parking meter 200 may be employed to sense the heat signature of an engine of a vehicle in the parking spot associated with the smart parking meter 100 to determine the occupancy status. The sensed heat signature may alone be employed to determine the occupancy status of the parking spot or be employed along with other imaged information to determine the occupancy status.

In accordance with the present invention, the sensing unit 230 collects additional information from a parked vehicle or vehicles passing nearby. For instance, in the embodiments using digital vision sensors, the parked vehicle's front or rear may be captured and the backend server 100 performs optical character recognition or other suitable image processing techniques on the obtained images to determine, for example, license plate information or expired registrations. In another instance, the vision sensors may detect the speed of passing vehicles.

The term “license plate” as used herein refers to a license plate of a vehicle issued by a state or any other governing body (e.g., country or other jurisdiction) with such authority to issue a license plate. The information on a license plate may include the alpha-numeric information and/or the identity of the state (or country) of issuance, and other information included thereon. In certain embodiments, the “license plate” broadly covers other components that include information that uniquely identifies the vehicle, such as a component that includes the vehicle's “vehicle identification number” (VIN). While a license plate usually is located on the front and/or rear of a vehicle, it may be located at other locations.

In further accordance with the present invention, the smart parking meter 200 communicates wirelessly with the backend server 100 via a communication unit 250. The communication unit 250 may be a transceiver forming a two-way communication network such as a GSM, GPRS, WiFi, Bluetooth or free space optical communication network with other smart parking meters and other various entities described herein and communicates real-time information and updates as needed over time. The term “transceiver” as described herein may refer to a single device having the capability of both transmitting and receiving data wirelessly. In some instances, the term “transceiver” may be a combination of one or more transmitters and one or more receivers operating in conjunction to provide the two-way communication network. In certain embodiments, adjacent smart parking meters communicate with one another and share their visual information from alternate angles or other metrics to assist the backend server 100 in determining the occupancy status of the associated parking spots. In certain other embodiments, the communication unit 250 is also configured to wirelessly communicate with self-driving autonomous vehicles in order to assist such types of vehicles with parking. Other forms of communication may be employed, as appropriate.

In certain other embodiments, the communication unit 250 is also configured to wirelessly communicate with self-driving autonomous vehicles. These self-driving vehicles generally rely on techniques for measuring distance to a target by illuminating a pulsed laser light such as Light Detection and Ranging (LIDAR) method or other visual detection system for navigation and decision making. These methods are often inadequate in providing efficient navigation of the autonomous vehicles because they only provide sensory information from the point of view of the vehicle. In accordance with the present invention, a plurality of smart parking meters sense visual information of their surroundings and these information may be gathered at the backend server 100 where they are used to construct a detailed three-dimensional deep (depth) map of the streets or the surrounding. Such forms of analytics may be provided to autonomous vehicles that are in communication with the backend server 100 or that come within the vicinity of areas employing the plurality of smart parking meters 200. The embodiments of the present invention improves the safety of the navigation systems within the autonomous vehicles and also assist in finding parking, routing to the parking space and handling of payments directly through the vehicles autonomously.

The smart parking meter 200 of the present invention may include a display 260. Display 260 may be a liquid crystal display, a light emitting diode (LED) display, an organic light emitting diode (OLED) display, or other suitable display. Display 260 may be comprised of multiple display elements. In certain embodiments, the display 260 operates as a color beacon to indicate its state to nearby motorists and enforcement authorities. The display may have background lighting. The color beacon may display a single color to identify a particular status or a variety of colors in various patterns. The smart parking meter 200 may further emit one or more auditory notifications to supplement (or in lieu of) the color indicators. In one version, the smart parking meter 200 includes a series of LEDs mounted on several positions around the main body 210 to maximize visibility.

In certain embodiments, the smart parking meter 200 includes one or more operation units 270. Each operation unit operates to allow a user of the smart parking meter 200 to input information. The operation units 270 may be depressible buttons, but other forms of input components may be employed, such as a rotatable switch, toggle buttons, etc. The operation unit 270 may be employed in conjunction with the display 260 for on-screen navigation of the smart parking meter 200. The operation units 270 may be incorporated within display 260 whereby a touch-enabled display is provided that allows for both user input and output.

The smart parking meter 200 includes a power source 280. Power source 280 may be a rechargeable (or non-rechargeable) battery. If rechargeable, various techniques for recharging may be employed, including the use of solar cells disposed on the exterior of the smart parking meter 200 or at another location. In yet other versions, the power source 280 is external, such as by direct connection to a municipal power source. If connected to a municipal power source, the smart parking meter 200 may be used as a charging station for electric cars. In such instance, the parking meter may further include an extendable power cord that can be plugged into an electric car. The electric car then may be easily charged while the car is parked at the parking spot.

The components of the smart parking meter 200 as described herein are not limited to the foregoing description and figures. The smart parking meter 200 may include additional or fewer components without departing from the spirit or scope of the present invention. For example, in certain embodiments, the smart parking meter 200 may further comprise a location unit that ascertains location information of the smart parking meter 200 via GPS signal, WiFi, GPRS triangulation, or even visually through surrounding landmarks. In certain other embodiments, the location unit and the communication unit 250 may be combined with the processing unit 240 as part of a CPU. The physical geometry can also be modified through use of wall mounting fixtures to enable installation of a compact version of the smart parking meter for indoor parking space implementation, while preserving all the features and functionality of the pole mounted design for street parking.

Returning to FIG. 1, the system further includes one or more of the following: a desktop computer 300, a mobile device 400, a payment card 500, a unique ID tag 600, a vehicle 700, a command and control center 800 and a kiosk 900. As would be appreciated, the system may include (and generally would include) multiple units of such components.

Desktop computer 300 may be used by a registered user or a potential customer to access a webpage in order to interact with any of the smart parking meters deployed (or with any other modules in the system) including, but not limited to, making an account, viewing account details, making reservations, viewing user statistics, or viewing traffic and spot availability information. The registered user may also similarly interact with the system via a mobile device 400 through a mobile-friendly webpage or a downloadable mobile app.

When a user creates an account via either the desktop computer 300 or the mobile device 400 to use a smart parking meter in accordance with the present invention, the account creation process generally includes several operations. For example, the user may be required to identify a bank account, a debit card, a credit card or other payment mechanism to enable automated charging by the user.

In certain embodiments, the user optionally can register more than one vehicle. Preferably, the user is requested to provide information about the vehicle, such as make, model, color, year of the car, license plate, vehicle identification number (VIN), and/or other information about the vehicle. After completion of registration, the user then is enabled to access (e.g., reserve) the smart parking meters of the present invention, as further described herein.

In a variation, a user without an account may use the smart parking meter in accordance with the present invention by presenting a payment card 500 directly to the sensor. In such case, the presentation of the payment card 500 at the smart parking meter is processed by the backend server and a temporary account is created on the cloud for the user. The temporary account charges a fixed amount in advance to the payment card 500. This way, if the user returns next time and presents the same payment card, the user is immediately identified and the appropriate funds are removed from the temporary account.

The system further includes a unique ID tag 600 that may be issued when a user registers an account in anticipation of using a smart parking meter of the present invention. In certain embodiments, the unique ID tag 600 is placed within the vehicle and once the vehicle enters the parking spot, the meter senses the presence of the tag to verify the identity of the vehicle. In one version, detection of the tag initiates an auto-login of the associated parking meter. In other embodiments, the unique ID tag 600 is presented at a smart parking meter to be scanned by the meter's sensing unit as a log-in method. FIG. 1 further schematically shows a vehicle 700. As discussed herein, in certain embodiments the make, model, color, and/or license plate (and other characteristics) are identified from the images taken by the parking meter associated with the parking spot that vehicle 700 has parked in.

FIG. 1 further shows a command and control center 800. The command and control center 800 represents a service that is offered to municipalities (or an independent agency) in order to set prices and schedules, run studies to optimize parking rates, set congestion pricing, take meters offline during emergencies, street cleanings or for other reasons, such as to create an extra lane during peak traffic hours. The command and control center 800 may also communicate information about defective meters to a repair company/service and/or communicate violations of a smart parking meter to nearby enforcement officers or registered users.

The system further includes a kiosk 900. In certain embodiments, the kiosks 900 are distributed in select locations for users who have privacy concerns and want to use cash to get a smart visual card 910 that can be read by the sensors of the smart parking meter. In certain other embodiments, the kiosks 900 may also behave as wired nodes in the network, communicating with multiple smart parking meters via WiFi, for example, as a gateway to the Internet. In yet certain further embodiments, the kiosks 900 may also function as a WiFi hotspot.

### II. The Operation

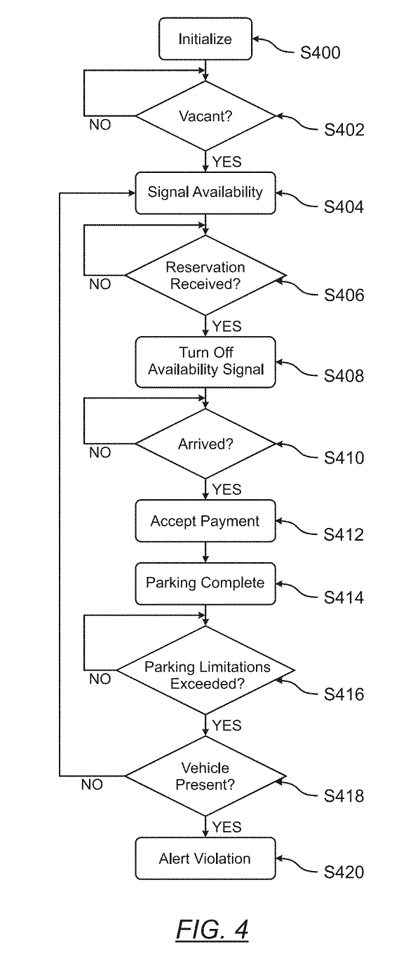

An exemplary operation of the smart parking meter in accordance with an embodiment of the present invention will now be described with reference to the flow chart shown in FIG. 4.

A particular smart parking meter is initialized at step S400. For instance, the smart parking meter is turned “on” with an instruction from the backend server. After initiation, the smart parking meter's sensing unit begins to function and begins obtaining information. The smart parking meter then proceeds to transmit the obtained information, preferably in real time, to the backend server where it is determined whether the associated parking space is vacant (S402). Such determination may be made via computer vision as described herein. Alternatively, the smart parking meter may employ an infrared sensing technique to obtain a heat map of the parking spot and transmit the information to the backend server for determining the occupancy status.

If the parking spot is determined to be vacant, the process moves to step S404. If the parking spot is not determined to be vacant, the process waits until the parking spot becomes vacant. At step S404, the backend server controls the smart parking meter to signal a parking spot availability to nearby motorists. This is achieved by, for example, a light emitting beacon on the smart parking meter (either an array of LEDs or a mounted display itself) flashing green light. Alternatively or in addition, the backend server provides availability information to one or more mobile devices of users on queue or to other interested motorists. The availability information is provided until the backend server receives a reservation of the particular parking spot (step S406). Once a reservation has been detected or otherwise is established for the particular parking space, the backend server transmits appropriate information to control the smart parking meter to end the availability signal (step S408). For instance, the parking meter is controlled to change the beacon from a flashing green light into a steady red light in order to inform nearby motorists that the parking spot is no longer available. If no reservation has been received in step S406, the process waits until a reservation is received.

After step S408, the smart parking meter continues sensing until a vehicle in the parking spot is detected. In accordance with the present invention, sensing by the parking meter and processing of the sensed information by the backend server are continuously carried out. Once an occupancy of the parking spot has been detected, verification of the vehicle can happen in several ways. In one embodiment, if the reservation is received from a user's mobile device, and routing to the parking spot is initiated on the mobile app, the backend server tracks GPS location of the mobile device (and hence the user's vehicle) and determines whether the user has arrived at the parking spot (step S410). In another embodiment, if the reservation has not been received from the user's mobile device, the backend server determines from the sensed information the make, model and/or color of the vehicle using computer vision object recognition algorithms and compares the determined make, model and/or color of the vehicle with the vehicle identification information included in the reservation information. If there is a match, it is determined that the user has arrived (step S410).

If the user has not arrived as indicated by GPS information (or there is no match from the comparison), the process waits until the user arrives.

Once the intended vehicle has arrived at the parking spot, a payment is accepted (step S412). During this step, the smart parking meter may emit a flashing red light to indicate that payment is expected. Once the payment has been made, the parking process is complete and the smart parking meter emits a steady green light (step S414).

In certain embodiments, upon receipt of payment, a timer is initiated in the event the parking spot has a parking time limit (e.g., a 2-hour parking limit). During step S416, the smart parking meter waits unit the timer expires. At expiration of the allotted amount of time, the system determines whether the vehicle still is present at the parking spot in step S418 and, if so, the backend server controls the smart parking meter to emit (in one form or another) a violation notice (step S420). The violation notice (also called violation signal herein) may be in the form of a visual notification (e.g., a red light) or an auditory notification. The violation signal may also be in the form of a push notification to the user's mobile device in order to alert the user (i.e., the driver of the vehicle) that the time has run out. On the other hand, if the parking spot is determined to be vacant at timer expiration (step S418), then the process returns to step S404, whereupon the system indicates that the parking spot is now available. Optionally, the parking spot is deemed to be available (i.e., the process returns to step S404) immediately or shortly after the vehicle departs from the parking spot prior to the expiration of the timer.

The foregoing process describes the operation of certain embodiments of the present invention. In other embodiments, the process may include additional or fewer steps. For example, the smart parking meter may implement a courtesy period of time to accept payment (in step S412). For instance, after the vehicle arrives in the parking spot (at step S410), the smart parking meter requires payment within a pre-set amount of time, such as within 3 minutes, within 10 minutes, etc. If payment is not received during this “courtesy period of time,” the parking meter indicates that a violation has occurred. In this version or in other versions, the reservation of the parking meter may be released if payment is not received within the courtesy period of time.

In certain further embodiments, the smart parking meter may require the vehicle operator to log into the smart parking meter. The operator may log into the smart parking meter manually via operation means provided on the smart parking meter. In another version, automatic login may be enabled, in which case the smart parking meter uses the visual information about the vehicle gathered through the sensor (e.g., make, model, color, plate number, etc.) to determine the identity of the operator and/or the vehicle and then to automatically initiate a login. In a further variation, the unique ID tag is placed on the vehicle (e.g., on the license plate) to assist in the identification using visual information. In such version, the tag may have patterns that are visible to the naked eye or have patterns that can only be read and decoded outside the visible range (e.g., infrared).

In yet certain further embodiments, after a car parks in an appropriately reserved parking spot, a time-stamp is generated in software for the purpose of calculating the parking duration. Various information, such as the smart parking meter number, the smart parking meter's address, the current parking rate (e.g., $0.10 per minute), any parking duration restrictions (e.g., a 2-hour parking limit), and other information, may be displayed on the smart parking meter and also, optionally, sent to the user (e.g., via email, text message, mobile app notification, or other technique). This information may be accessible through the mobile app for monitoring purposes by the user and also to assist the user in navigating back to the parking spot.

The process may further include using time-stamps to charge for the exact amount of time (e.g., down to the second) for using the parking spot. Notifications may also be sent to the user with the details of the transaction as a receipt for payment.

In one version, the user doesn't specify how long he/she plans to keep the vehicle in the parking spot. Rather, the user is automatically charged for the length of time the vehicle remains in the parking spot.

### III. Finite-State Machine Implementation

The smart parking meter of the present invention as described herein configures its associated parking spot to be in one of seven different states. Each state, and various transitions between the states, are as follows:

### State A—Empty-Online

This is an initial state of the parking spot. In this state, the parking spot is accepting customers and the smart parking meter advertises the availability using, for example, a color beacon on the meter by a flashing green light. As will be further described below in reference to the mobile app implementation, an indicator for this state in the mobile screen may be a green pin.

### State B—Empty-Offline

In this state, the parking spot is offline and no vehicle should be present at the parking spot. Transition from State A to State B may occur when, for example, an extra lane must be opened on a street or to accommodate alternative street side cleaning. During this state, the color beacon emits a steady red light and in the mobile screen, an indicator for this state may be a red pin or no pin (i.e., the spot is not shown at all).

### State C—Empty-Reserved

This state is achieved when a parking spot becomes “reserved.” During this state, even though no vehicle is occupying the parking spot, the beacon emits a steady red light to alert other motorists that this spot is unavailable. An indicator for this state in the mobile screen is also a red pin.

### State D—Empty-In Progress

This state is initiated when an active routing is in progress. For example, this state is entered when a user opens the app, selects a parking spot and confirms that the user wants to park in that spot. The system takes the spot offline until the user arrives and parks. The spot remains empty during this phase but the beacon emits a steady red light and in the mobile screen, a green pin is shown for the user in the process of parking and a red pin is shown for everyone else.

### State E—Occupied-Awaiting

This is an initial state when a vehicle has pulled into the parking spot. During this state, the smart parking meter is verifying the vehicle and/or expecting a payment. During this state, the smart parking meter may also start the courtesy timer the moment the parking spot enters this state. The beacon flashes a red light and a red pin is also indicated in the mobile screen during this state.

### State F—Occupied-Activated

This state is initiated when the user has successfully logged into the smart parking meter or a payment has otherwise been processed. When this state is entered, the beacon emits a steady green light. In certain embodiments, the green light will turn off after a predetermined amount of time (e.g., 30 seconds) to save the battery life of the smart parking meter. In the mobile screen, a green pin is shown for the user but a red pin is shown for everyone else.

### State G—Occupied-Violation

This state happens when the parking spot remains in State E beyond the allotted courtesy time without transitioning to State F. This state can also be transitioned from State F when one or more parking limitations have been met (e.g., 2-hour parking limit). This state can also be achieved when a user parks at a wrong spot or a wrong user has parked at a designated parking spot. This may occur when a motorist ignores the steady red light on the smart parking meter and parks at the spot, resulting in a violation. The beacon emits a steady red light and a red pin is used in the mobile screen.

A full finite-state machine (FSM) diagram, FSM input vectors and FSM transition table are provided in Appendix A.

### IV. Single-Click Parking Methodology

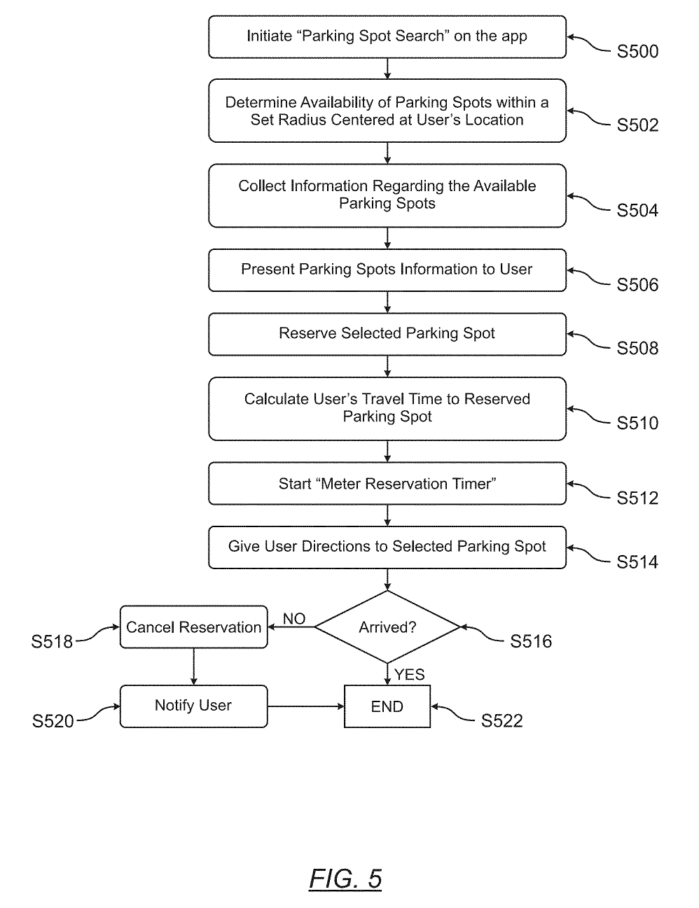

Referring now to FIG. 5, a “single-click parking” methodology in accordance with the present invention is illustrated.

In step S500, the user initiates a “Parking Spot Search” feature on the mobile application. Prior to performing this step, the user may be required to complete a set of steps to register an account with a service provider. Various steps to initialize a user's account with a mobile app, such as the process of downloading an app, creating an account using an email address or other social media account, creating login credentials, and associating a debit/credit card, are well known and further descriptions of those steps will be omitted. In addition to performing basic initialization, a user may be required to register the user's vehicle information, such as make, model, color, and/or license plate number with the mobile app.

After the “Parking Spot Search” has been initialized by the user, the mobile app determines the user's physical location using, for example, the built-in GPS feature of the mobile device and determines available parking spots within a pre-set radius centered around the user's location (step S502). Alternatively, the mobile app may require the user to enter an address of the user's destination and perform the determination of available parking spots within a pre-set radius centered around the user's destination. If a map is displayed, the user can select the desired destination by touching the location of the destination on the map.

In certain embodiments, as part of step S502, when the mobile app is not able to find any available parking spots within the set radius of the user's location or the user's destination, the mobile app may place the user on queue. When the user is placed on the queue, the mobile app may start a “User Queue Timer,” to determine the length of time the user has spent on queue and to prioritize a group of users on queue based on the length of time. In certain embodiments, for a fee, or for VIP users, it may be possible to jump ahead in the queue. When a parking spot becomes available within the pre-set radius, the mobile app notifies the user and removes the user from the queue. In certain other embodiments, the mobile app notifies only when the user is first in queue or if the user's current location is closest to the available parking spot. In yet certain further embodiments, the mobile app may remove users from the queue once a predetermined time has passed and no parking spots have become available.

Once one or more available parking spots have been identified, the mobile app collects information regarding the available parking spots (step S504). The collected information may include the spot's parking rate, duration, size and/or location. The information may already be stored in the server or obtained in real-time via the sensors placed on the parking meters. After the information has been gathered, the mobile app presents to the user information relevant to the available parking spots (step S506). In certain embodiments, the presentation may be in the form of colored pins dropped on a map screen. For example, the mobile app may drop a green pin on the map screen at the precise location for each of the available parking spots. In certain other embodiments, when the user selects a pin, a pop-up window containing the relevant information may be displayed. In such embodiments, the information relating to each of the available parking spots may also be presented together in a table format for comparison. In yet certain further embodiments, different colored pins may be used to indicate unavailable parking spots. In such embodiments, when the user selects an unavailable parking spot, the mobile app may present to the user information such as the amount of time the selected parking has been unavailable, the time the selected parking spot will become available, or whether further reservations have been made on the selected parking spot.

Upon receiving the list, table, or any other graphics of available parking spots and their associated information, the user makes a selection of a desired parking spot. When the user has selected a parking spot, the mobile app proceeds to reserve the selected parking spot (step S508). The reservation may be indicated to the user, or to any other users, by a change in the color of the displayed pin, or the selected pin disappearing from the map screen entirely.

When the user's selection of an available parking spot has been registered, the mobile app calculates the user's travel time from the user's current location to the reserved parking spot (step S510). Once the user's travel time has been calculated, the mobile app starts a “Meter Reservation Timer” with the amount of time corresponding to the calculated user's travel time (step S512). In certain embodiments, the reservation of the selected parking spot may expire once the amount of time allocated by the Meter Reservation Timer is up, regardless of whether the user has successfully arrived at the reserved parking spot. In certain other embodiments, once the amount of time allocated by the Meter Reservation Timer is up, the status of the selected parking spot “resets,” and becomes available for other users. For example, the resetting of the status may be indicated on the user's mobile device by changing the color of the selected pin back to green. In yet certain further embodiments, the Meter Reservation Timer is pre-set to a predetermined amount of time (e.g., 2 minutes or less). In still certain further embodiments, the amount of time allocated by the Meter Reservation Timer is added on top of the calculated user's travel time, functioning as a buffer time to allow the user to park the vehicle at the parking space. After, or in conjunction with the start of the Meter Reservation Timer, the mobile app may also provide to the user driving directions to the selected parking spot (step S514).

In the meanwhile, the backend server continuously controls the smart parking meter to obtain real-time information of parking spot occupancy to determine whether the user has arrived (step S516). In certain embodiments, if the user has arrived at the selected parking spot prior to expiration of the amount of time allocated by the Meter Reservation Timer, the parking meter communicates a notification over the network and the mobile app stops the Meter Reservation Timer. In certain other embodiments, the user may be required to input his arrival at the parking spot by logging in directly through the mobile app.

When the parking meter has determined that the user has not arrived in the allotted amount of time, it may also communicate a notification over the network to cancel the meter's reservation (step S518). Once the user's reservation has been canceled due to expiration of the Meter Reservation Timer, the user may be notified of the cancellation (step S520). In certain embodiments, the same user may be given a short amount of time (e.g., 10 seconds, 30 seconds, etc.) to re-reserve the parking spot before the parking spot becomes publicly available to other users. Once the user has arrived at the parking spot on time or the reservation has expired, the process ends (step S522).

The foregoing process described with reference to FIG. 5 may be simplified to a customer already registered as a user of the smart parking meter management system. For example, the user may drive to the destination and upon arrival or within a few minutes of arrival, and opens the mobile app (the app could also be used as a turn-by-turn navigation tool to drive to the destination). On the “home screen,” the user presses a single button which will initiate a search for any available parking spots in a pre-set radius (e.g., 300 feet) centered at the user's vehicle. Alternatively, as long as the user is on the “map screen,” the parking spots update their status in real-time and no input from the user is needed. The available parking spots are then presented, along with additional information such as parking rate, parking restriction (e.g., 2 hour parking limit), and driving distance to the parking spot. The user selects an available spot and upon confirming the selection, the parking spot is taken off the availability list. In certain embodiments, this is achieved by a beacon on the parking meter transitioning from flashing green to a steady red. This short-term reservation is only held for the period of time it takes the user to navigate to the parking spot plus an extra buffer (e.g., 1 or 2 minutes) to allow for parking. During this time, no other motorist can park in the spot and even if they do, they will not be able to log into the parking meter because it has already been reserved by the user. In certain further embodiments, within this period of time, the parking meter will only accept payment from the user who initiated the reservation through the mobile app. In the case where no parking spots are available, the user is added to a queue, which notifies users as a parking spot becomes available. This feature efficiently routes motorists to parking spots, reducing traffic load and the frustration of having to circle the block looking for a parking spot.

The foregoing process described with reference to FIG. 5 can also be implemented as a future reservation feature, whereby a user can reserve a spot in the future for a set amount of time, generally for a fee. The reserved meter is taken offline (or the meter changes its visual notification from flashing green to a steady red) during that time period as described herein. Any motorist parking in the spot within a set amount of time before the reservation is then notified of the parking limitation upon logging into the meter (both on the meter display and on mobile notification). As a variation, the motorist may be notified while choosing the spot to be routed to via the mobile app. The reservations can be set incrementally for a limited amount of time or be flexible. The reservations can be for a specific spot, or be flexible such that they can be changed to a nearby spot by a management system to maximize occupancy of all spots.

### V. Payment Processing

A process for making a payment using the smart parking meter in accordance with the present invention will now be described in greater detail. In accordance with the present invention, all physical forms of payment are accepted except for cash. In certain embodiments, cash may be accepted only at the kiosks to receive a smart card, to top up an existing card, or to add balance to an account. For instance, the smart parking meter can process credit cards, debit cards, app-based on-screen payment vouchers, or physical prepaid cards and/or vouchers through the sensor (e.g., camera) via optical character recognition (OCR). In one version, the smart parking meter may process payment information through RFID transceivers, or by using other non-contact electromagnetic readers.

In accordance with certain embodiments of the present invention, the smart parking meter will not accept cash, thereby eliminating the need for conventional meters that are built as metallic security deposit boxes. The smart parking meters can therefore be made from lighter composite materials, and drastically reduce the manufacturing cost. In addition, with no openings for inserting cash or cards, the smart parking meter can be completely hermetically sealed in order to improve weather proofing.

Further in accordance with the present invention, cash kiosks can be utilized at a much smaller number ratio to the meters, placed in various locations around the city. Motorists can receive a unique parking prepaid card (to be read by the smart parking meter's sensor) at these kiosks by using cash (or other payment methods) to add funds to the card or check their balances.

In certain embodiments, payment is processed via an online account. The online account allows customers to link various forms of online payment (credit cards, debit cards, PayPal, Apple Pay, Android Pay, bank account or crypto currency such as bit-coins, etc.) to their account. This information can be used to both add a balance to the account in the form of “parking credit” or used on a pay-as-you-go basis. Upon registration, contact information for the user (e.g., name, address, phone number, or email address) and vehicle information (e.g., make, model, or license plate number) may be gathered. Each motorist is then issued a unique tag with every vehicle that is registered with the account. The tag can be kept in the vehicle and be used as a form of login mechanism at the smart parking meter by having the sensor read the tag information.

Alternatively, the user's mobile device and its onboard camera can be used to scan the ID of the smart parking meter (e.g., QR code, barcode or number sequence), or the ID can be entered by the user in a text field on the app manually. In one version, a unique code can be generated by the user's mobile device for each transaction, and then presented by the user to the smart parking meter to be scanned.

### VI. Enforcement

A process for enforcing parking regulations in a street parking infrastructure including the smart parking meter of the present invention will now be described. In accordance with the present invention, all smart parking meters are monitored and controlled via a command and control center located at a remote location. The sensors (e.g., cameras) within the smart parking meters are remotely accessible from the command and control center via a secure connection for security and monitoring purposes. The sensors capture still or video images which may or may not be stored for evidence in criminal proceedings or for training purposes. The enforcement is as automated as possible but in case of any ambiguity (e.g., blurry image of a number plate), the command and control center can prompt the attention of a human administrator for clarification. The information can also be automatically submitted for clarification through crowdsource services (e.g., image based captcha).

In accordance with the present invention, the concept of parking fines may be eliminated. In its place, the parking enforcement authorities have the option of progressively pricing the meter rate. For example, to enforce a 2-hour parking limit, the parking rate can stay relatively flat up until the limit and then increase more aggressively, as a predefined function of time. However, in extreme circumstances, fines and towing penalties are also an option. The parking enforcement authorities can use analytics generated by the embodiments of the present invention to optimize the meter pricing and have the flexibility of altering prices at will (e.g., in case of a special event such as a football game in the vicinity) to optimize profits.

The parking enforcement authorities can also take smart parking meters offline remotely from the command and control center in case of emergencies. For example, the command and control center can control the smart parking meters to open an extra traffic lane in case of an accident, or to gain access to the parking spots for cleaning or clearing snow/debris or for the use by commercial delivery vehicles, preventing double parking and easing congestion. In each case, the motorist already parked at the location is informed (e.g., via mobile app, email, text message, etc.) to attend to the situation and operation of the smart parking meters is changed so as to not accept any new customers (e.g., beacon on steady red light).

The present invention also provides added security benefits to the motorists as they are informed immediately if their vehicle is removed without their knowledge (e.g., stolen or towed). By analyzing the captured images in the infrared, or any other means, presence of foreign bodies within or near the vehicle can also be detected, alerting the user to the possibility of a larceny. At this stage, the user can be given permission to view a live-feed from the smart parking meter's camera and alert the authorities in case of noticing anything suspicious. The information regarding the crime being committed (time, location, witness information, etc.) can then be automatically stored and relayed to the authorities in the form of a “panic” button on the mobile app, reducing the response time.

### VII. Mobile App Implementation

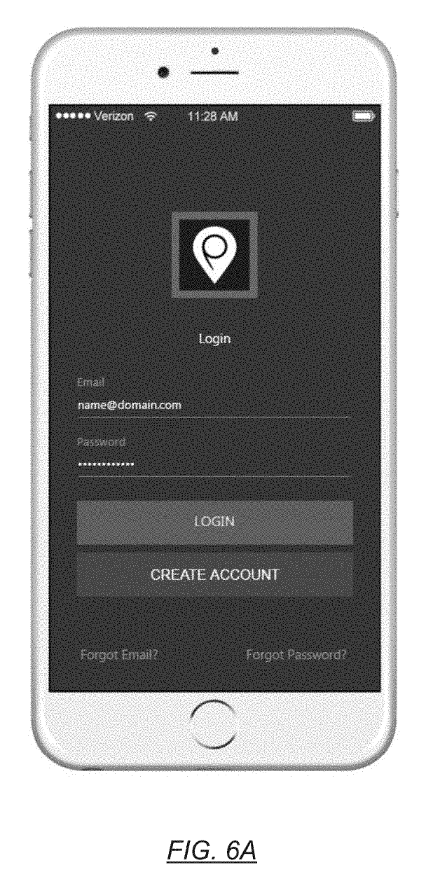

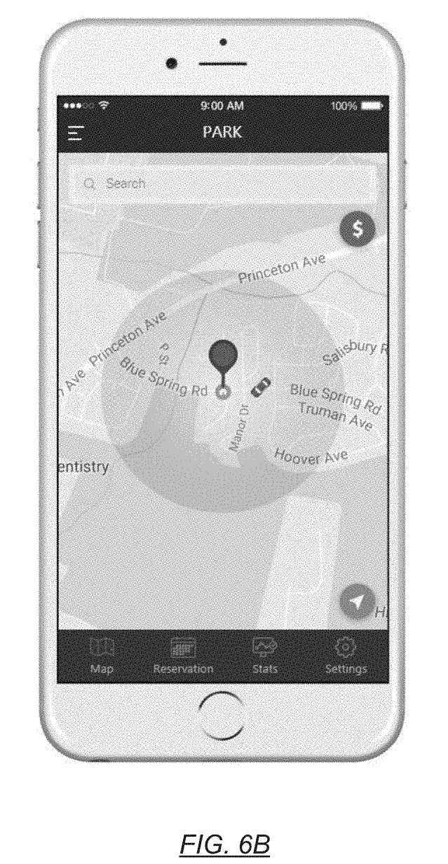

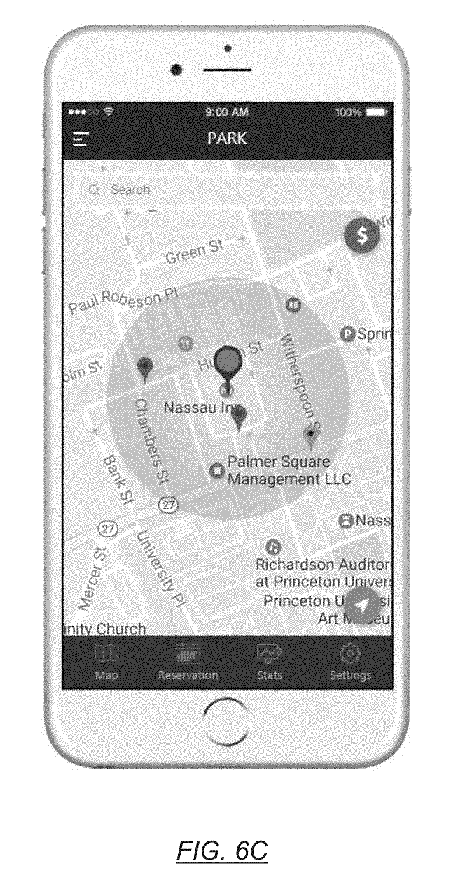

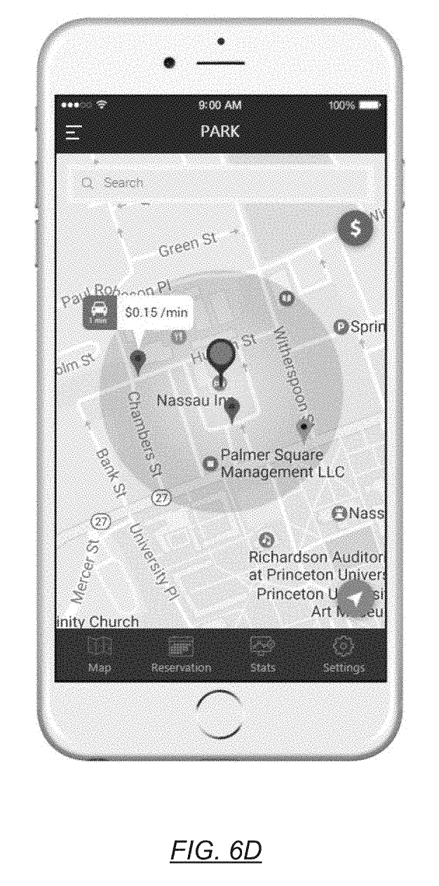

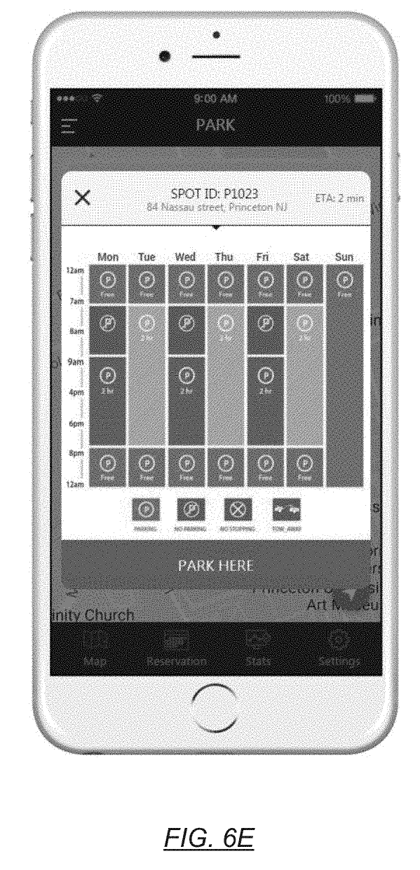

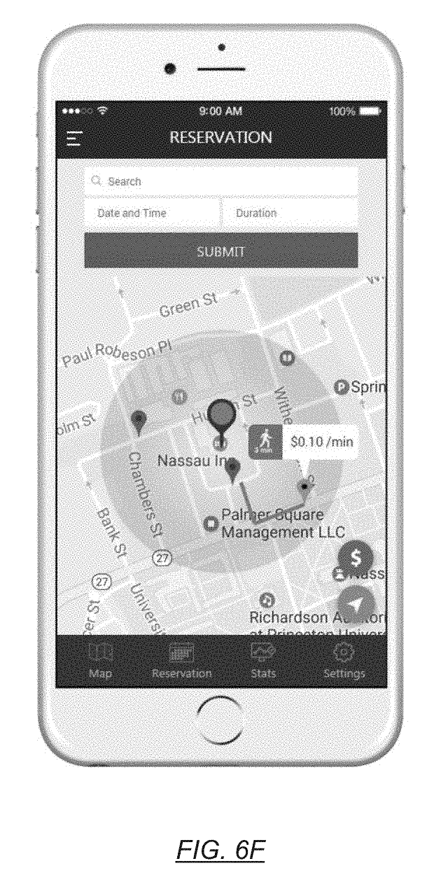

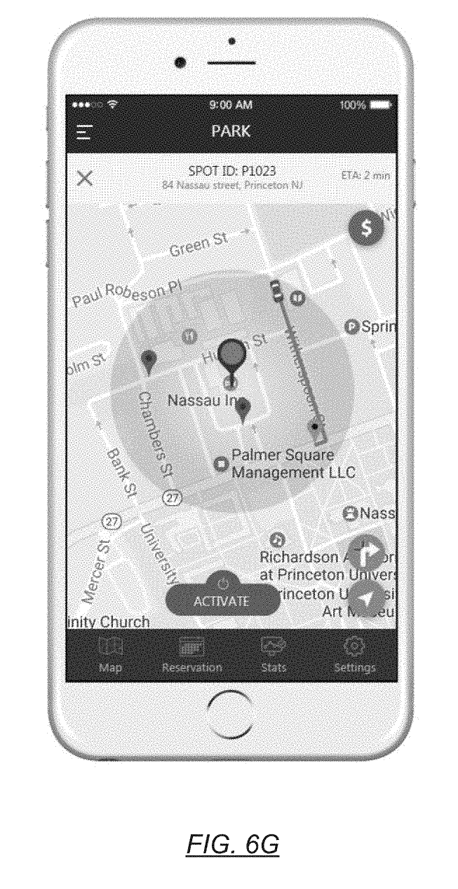

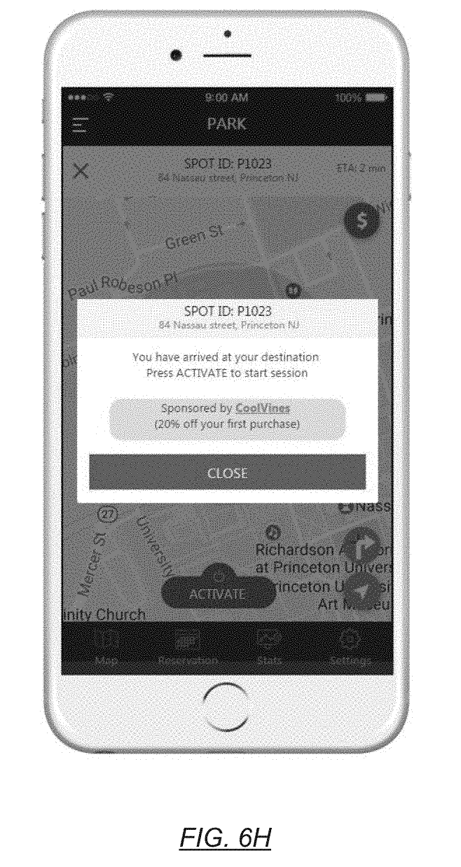

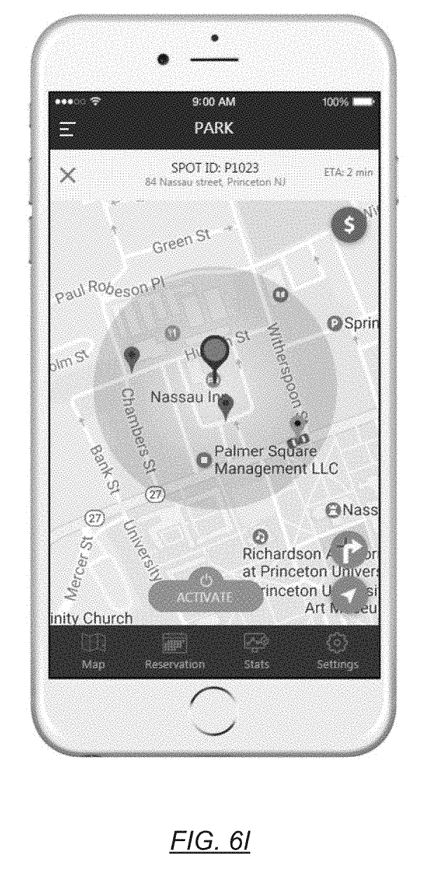

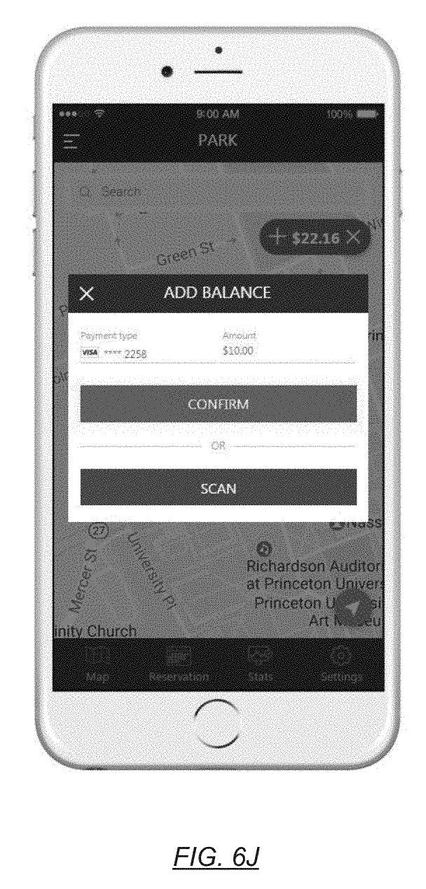

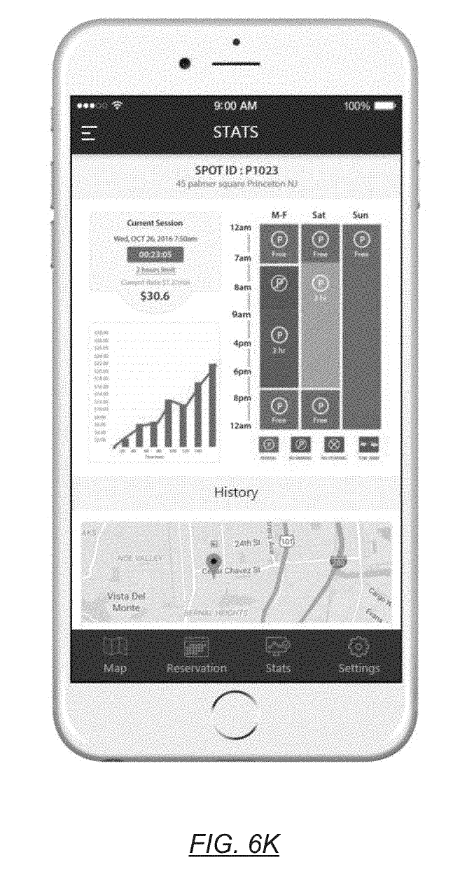

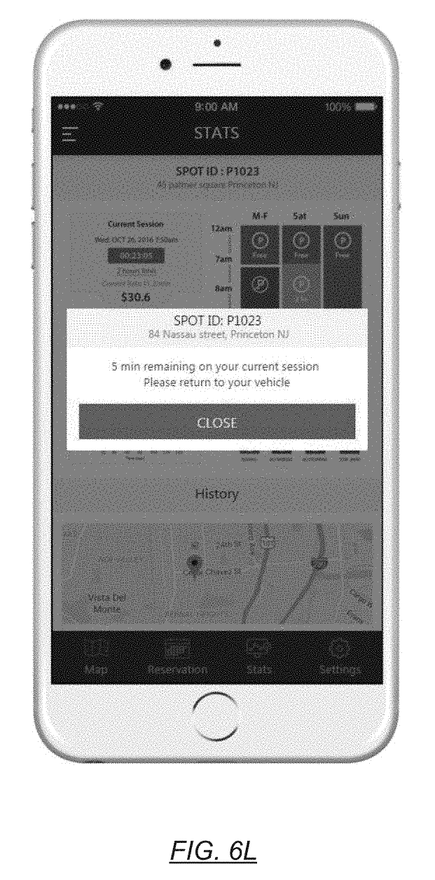

A mobile application implementation of the present invention may be used to execute various processes as described herein, for example, the “Single-Click Parking” operation or other processes such as registering an account, associating vehicle information, processing a payment, and more. An exemplary mobile app implementation will now be described using exemplary screenshot images as shown in FIGS. 6A-6L.

FIG. 6A shows a log-in screen of the mobile app. On this screen, a user may enter his or her login credentials or create an account. FIG. 6B shows a home screen after the user has successfully logged into the mobile app. The home screen is configured as a map screen centered around the user's current location. FIG. 6C shows a follow-up map screen after the user has entered a destination. The follow-up map screen includes a number of available parking spots each associated with a smart parking meter of the present invention (e.g., two parking spaces for every smart parking meter).

FIG. 6D shows basic information on a pop-up bubble of the parking spot that has been selected by the user. For example, the pop-up bubble shows current parking rate and user's drive time to the selected parking spot. FIG. 6E shows more detailed information regarding the selected parking spot once the user clicks on the pop-up bubble. FIG. 6F shows a screen in which the mobile app prompts the user to submit a reservation request for a future reservation of a parking spot. FIG. 6G shows an on-demand nature of the parking/routing. FIG. 6H is a screen showing an arrival message window. The arrival message window pops up when, for example, the user has parked in the reserved parking spot and the smart parking meter has performed verification of the parked vehicle with the registered information. In certain embodiments, the arrival message window may include targeted advertisements as further described herein.

FIG. 6I shows a screen of the mobile app requesting the user to activate parking. As described herein, the activation leads to an end of the courtesy period which began when the parking spot became occupied. The activation may also lead to counting of parking duration. FIG. 6J shows a screen for processing payment. In certain other embodiments, the payment is automatic and the user may be presented with a final charge for the duration of the parking. While the user's vehicle is legitimately parked at a parking spot, the user may access current parking information as shown in FIG. 6K. The current parking information include data such as the duration of the parking, the current charge, or the location of the parking meter.

FIG. 6L shows a warning screen including a message that an allotted time for using a parking spot is expiring. The mobile app may further issue a warning notification even when the mobile app is not open to alert the user that the parking meter is expiring, through the use of push notifications, text messages, emails, phone calls, and etc.

### VIII. Other Embodiments

Another feature made available in accordance with the present invention is for merchants and businesses in an area to sponsor parking for their customers (i.e., the Merchant Pay program). The Merchant Pay program is available for a participating merchant to pay for the parking of its patron at the point of sale. This may be done by the patron scanning a visual (barcode, QR code, etc.) or a non-visual marker (NFC tag, RFID tag, etc.) at the point of sale. In certain embodiments, this can be achieved via a promotion where a merchant sponsors one or more parking spaces and pays for the parking ahead of time for any customer using the one or more parking spaces. Other similar variations may be employed so as to allow merchants to absorb the cost of parking around their stores and to attract more customers. In certain other embodiments, the merchant can credit its customers through a variety of payment options previously discussed, for both registered and unregistered users using prepaid cards or coupons. In another embodiment, the merchant can apply for and receive a special tag that can be implemented as a physical number tag, a barcode tag, a QR code tag, a RFID tag, a Bluetooth tag, a WiFi tag, an infrared-based optical tag or a magnetic tag that will be accessed by a registered customer's mobile device to receive credit. The code can also be generated on-screen via a special feature on a business-version of the mobile app on the merchant's desktop, mobile device, or terminal, or through any other device producing print and/or digital copies.

Yet another feature made available in accordance with the present invention is geo-location advertising. In certain embodiments, when a user is using the mobile app to navigate to a selected parking space, a targeted advertisement may be presented to the user upon arrival. For example, a backend server in accordance with the present invention may build a database of advertisements. The advertisements may be received from companies, businesses and/or other retail stores offering services and/or products (collectively, the “retailers”). The retailers may be located near or within a predetermined area of where the parking meters are deployed. For example, the backend server may build a separate database for each section of a city that employs the smart parking meters in accordance with the present invention.

When a motorist makes a reservation of a parking space (either on-the-spot or for a future date and time), and the motorist arrives at the reserved parking space, the motorist may be prompted to activate the parking duration via a mobile device. During activation, either on the activation screen or on a screen immediately following the activation screen, the backend server delivers a targeted advertisement. The advertisement is considered as “targeted” since the advertisement is directly provided to the right person, at the right time and at the right location. The process for “targeting” may vary across different embodiments. In certain embodiments, the advertisement of a retailer having the closest physical location (i.e., within a few minutes of walking distance) to the reserved parking space is presented. In certain other embodiments, a plurality of advertisements may be presented.

Yet a further feature made available in accordance with the present invention is providing navigation systems in heavily built-up areas. GPS signals in heavily built-up areas, such as Manhattan, may be very inaccurate and noisy. In accordance with the present invention, the smart parking meters may act as navigation beacons, such that a vehicle can triangulate its position off a signal from the smart parking meters to assist in precise determination of the vehicle's location.

It is appreciated that while the present invention has been described with reference to specific schematics, diagrams, and descriptions, various changes may be made without departing from the spirit and scope of the invention.

For example, wall mounted (or other) compact forms of the smart parking meter retaining all the functionality as described herein may be utilized within the Internet-of-Things (IoT) implementation of the present invention. The IoT implementation of the present invention is efficient in settings such as private residences (or other indoor or private area) to monetize their driveways or similar parking areas.

Still further, other variations may be made as would be appreciated to those of ordinary skill in the art. Therefore, it is to be understood that other expedients/variations may be employed but that stay within the meaning, scope and spirit of the invention.

Having described the present invention including various features and variations thereof, it is intended that the appended claims be interpreted as including the embodiments described herein, the alternatives mentioned above, and all equivalents thereto.

What is claimed is:

1. A parking space management system, comprising:
a plurality of parking meters, each of the parking meters including a respective main body, processor, sensor and transceiver, the sensor of each said parking meter configured to sense visual information relating to one or more parking spaces associated with the respective parking meter, and the transceiver configured to externally transmit the sensed visual information; and
a backend server configured to remotely control a selected one or more of said plurality of parking meters, the backend server further configured to:
receive the transmitted sensed visual information from at least one of the parking meters;
process the received sensed visual information via computer vision to determine an occupancy status of the one or more parking spaces associated with said at least one of the parking meters;
control said at least one of the parking meters to display a first status notification indicative of the determined occupancy status of the one or more parking spaces associated with said at least one of the parking meters; and
establish a reservation for a selected parking space and control the parking meter associated with the reserved selected parking space to display a second status notification indicative of the reservation.

2. The parking space management system of claim 1, wherein the backend server is configured to establish the reservation upon receipt of a request for a reservation transmitted from an external device.

3. The parking space management system of claim 2, wherein the reservation includes at least one vehicle identification information.

4. The parking space management system of claim 3, wherein the backend server is configured to determine whether the vehicle identified by the vehicle identification information included in the reservation has entered the reserved selected parking spot; and the backend server is configured to control the parking meter associated with the reserved selected parking space to display a third status notification indicative of a violation when it is determined that a vehicle different than the vehicle identified by the vehicle identification information has entered the reserved parking space.

5. The parking space management system of claim 4, wherein the backend server is configured to disable a processing of a payment for parking in the reserved parking space when it is determined that a vehicle different than the vehicle identified by the vehicle identification information has entered the reserved parking space.

6. The parking space management system of claim 4, wherein the backend server is configured to make the determination of whether the vehicle identified by the vehicle identification information included in the reservation has entered the reserved selected parking spot by ascertaining at least one of make, model and color of the vehicle in the reserved parking space from the received sensed visual information of the reserved parking space and comparing the ascertained information with the vehicle identification information included in the reservation.

7. The parking space management system of claim 4, wherein the backend server is configured to make the determination of whether the vehicle identified by the vehicle identification information included in the reservation has entered the reserved selected parking spot by utilizing location information of the vehicle identified by the vehicle identification information in the request for reservation.

8. The parking space management system of claim 1, wherein each of the parking meters includes a beacon disposed on or within the main body and configured to display a selected one of a plurality of different status notifications.

9. The parking space management system of claim 1, wherein each of the parking meters includes an infrared sensor to detect a heat map of the one or more parking spaces associated with the respective parking meter.

10. The parking space management system of claim 1, wherein each of the parking meters includes a plurality of solar cells and a power source configured to power the respective parking meter and configured to be rechargeable via the respective solar cells.

11. The parking space management system of claim 1, wherein each of the parking meters is configured to receive power from an external power source and further configured to operate as a charging station for one or more electric vehicles.

12. The parking space management system of claim 1, wherein the backend server is configured to initiate a timer having a predetermined amount of time when a parking space becomes occupied.

13. The parking space management system of claim 12, wherein the backend server is configured to control a parking meter associated with an occupied parking space to display a third status notification indicative of a violation when the timer expires and a payment for said occupied parking space has not been processed.

14. The parking space management system of claim 1, wherein the backend server is configured to process sensed visual information received from a predetermined plural number of said parking meters to generate a three-dimensional depth map of areas surrounding the predetermined plural number of said parking meters.

15. The parking space management system of claim 14, wherein the backend server is configured to provide the generated depth map to an autonomous vehicle both in communication with the backend server and disposed within a predetermined distance of the predetermined plural number of said parking meters.

16. The parking space management system of claim 1, further comprising storage having stored therein a database of advertisements from retailers located within a predetermined area in association with said plurality of parking meters,
wherein the backend server is configured to:
detect an arrival of a vehicle within a selected parking space;
select at least one of the advertisements within the database of advertisements stored in the storage, the selected advertisement being associated with a retailer having a physical location disposed within a predetermined walking distance from the selected parking space; and
transmit, at the arrival of the vehicle within the selected parking space, the selected advertisement to a mobile device associated with an operator of the vehicle.

17. A method of managing parking spaces, the method comprising:
obtaining visual information relating to one or more parking spaces associated with each of a plurality parking meters;
processing the obtained visual information via computer vision to determine an occupancy status of the one or more parking spaces;
controlling the plurality of parking meters to display a first status notification indicative of the determined occupancy status;
establishing a reservation of a parking space associated with at least one parking meter; and
controlling the at least one parking meter to display a second status notification indicative of the reservation.

18. The method of claim 17, further comprising:
processing the obtained visual information to generate a three-dimensional depth map of areas surrounding said plurality of parking meters; and
providing the generated depth map to one or more autonomous vehicles within a predetermined radius of the plurality of parking meters.

19. The method of claim 17, further comprising:
establishing a database of advertisements from retailers within a predetermined area of said plurality of parking meters;
detecting an arrival of a vehicle within a selected parking space;
selecting an advertisement from the database of advertisements, the selected advertisement being associated with a retailer having a physical location that is within a predetermined walking distance from the selected parking space; and
transmitting the selected advertisement to a mobile device associated with an operator of said vehicle at the time of arrival.

20. A parking meter, comprising:
a main body;
a sensor disposed on or within the main body, the sensor configured to continuously sense visual information relating to a parking space associated with the parking meter;
a beacon disposed on or within the main body and configured to emit at least one of a visual notification and auditory notification indicative of a status of the parking meter;
a processor configured to encrypt the sensed visual information to be externally transmitted; and
a transceiver configured to transmit the encrypted sensed visual information to an external backend server for computer vision processing.
